(19) United States
(12) Patent Application Publication
(10) Pub. No.: US 2020/0211059 A1
(43) Pub. Date: Jul. 2, 2020

(54) SYSTEM AND METHOD FOR PROVIDING TRAVEL AND LODGING SERVICES

(71) Applicant: JPMorgan Chase Bank, N.A., New York, NY (US)

(72) Inventors: Ajinkya P. JOGLEKAR, Philadelphia, PA (US); Manning R. FIELD, Media, PA (US)

(21) Appl. No.: 14/571,575

(22) Filed: Dec. 16, 2014

(51) Int. Cl. G06Q 30/02; G06Q 50/12; G06Q 50/14

(52) U.S. Cl. CPC G06Q 30/0255; G06Q 50/14; G06Q 50/12

(57) ABSTRACT

The invention relates to a computer-implemented system and method for providing travel and lodging information to a customer of a business such as a financial institution, according to one example. The method may comprise the steps of: storing customer profile data; storing hotel profile data on a plurality of hotels; sending to the customer's mobile device a list of candidate hotels and hotel amenities; receiving from the customer's mobile device a selection of a hotel within the list of candidate hotels; inviting the customer to make a special request to the selected hotel and relaying the customer's special request to the selected hotel; and prior to the customer's arrival at the selected hotel, sending to the selected hotel a data set including customer profile data that is derived from financial transactions independent of the selected hotel and other data maintained by the business and not maintained by the selected hotel.

### FIELD OF THE INVENTION

The invention relates generally to a system and method for providing travel assistance relating to lodging, and more particularly to a system and method for enhancing a traveler's experience at a hotel or other lodging establishment by providing relevant information, options, and/or offers to the traveler's mobile device before and during the stay and providing relevant traveler information to the hotel during the stay.

### BACKGROUND

Hotels providing lodging for travelers generally gather a standard set of data from their guests. For example, a traveler booking a hotel room is generally required to provide check-in and check-out dates, address and contact information, and a credit card number and expiration date. Many hotels also have rewards programs to promote loyalty and therefore collect data on the spending levels of their guests. And hotels may collect data on the room preferences of their guests (e.g., preference for non-smoking room on higher floor).

However, hotels generally have relatively limited information on other characteristics of the traveler, their preferences, their full itinerary, or other planned events outside of the hotel. Furthermore, hotels generally have little or no opportunity to obtain such information from their guests who are primarily interested in getting to their room upon arrival. Accordingly, hotels traditionally have not be able to significantly enhance or improve the traveler's experience by offering advice, options, events, special offers, or other information that might improve the traveler's overall experience on the trip. It would be desirable, therefore, to have such a system and method that could improve the traveler's experience.

### SUMMARY

According to one embodiment, the invention relates to a computer-implemented system and method for providing travel and lodging information to a customer of a business, such as a financial institution. The method may be conducted on a specially programmed computer system comprising one or more computer processors, mobile devices, electronic storage devices, and networks. The method may comprise the steps of: storing customer profile data on a computer server; storing hotel profile data on a plurality of hotels on the computer server, wherein the hotel profile data comprises data on characteristics of the hotel; generating with a specialized computer processor a list of candidate hotels based on a relationship between the customer profile data and the hotel profile data; sending to the customer's mobile device via a network a list of candidate hotels and hotel amenities; receiving from the customer's mobile device via a network a selection of a hotel within the list of candidate hotels; inviting the customer, via the customer's mobile device, to make a special request to the selected hotel and relaying the customer's special request to the selected hotel via a network; and prior to the customer's arrival at the selected hotel, sending to the selected hotel via a network a data set including customer profile data that is derived from financial transactions independent of the selected hotel and other data maintained by the business and not maintained by the selected hotel.

The invention also relates to a computer implemented system for providing travel and lodging information to a customer of a business, and to a computer readable medium containing program instructions for executing a method for providing travel and lodging information to a customer of a business.

The customer profile data may comprise, for example, historical data on financial transactions executed by the customer, information manually input by the customer into his or her profile, or passively collected data on other interactions with the financial institution, e.g., browsing behavior of the customer on the financial institution's website.

The computer implemented system, method and medium described herein can provide the advantage of increasing customer loyalty to a business, such as a financial institution, based on the perception that the business is significantly enhancing the customer's experience on a planned trip. The system can enhance the customer's experience in number of ways, including by identifying desirable candidate hotels that closely match the customer's profile, providing relevant information on the recommended hotels, such as images and hotel amenities, to enable the customer to evaluate each candidate hotel, inviting the customer to make special requests of the hotel, relaying those requests to the hotel, and confirming that they have been honored, identifying recommended events and destinations near the selected hotel based on the customer profile, sending room upgrade offers prior to the customer's arrival at the hotel, and sending relevant customer profile information to the hotel staff prior to the customer's arrival to enable the hotel staff to make customized recommendations to the customer during his or her stay. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for providing travel and lodging assistance according to one embodiment of the invention.

FIG. 2 is diagram showing examples of components of a system for providing travel and lodging assistance, including third party services and a hotel system, according to one embodiment of the invention.

FIG. 3 is an example of a screen on a travel app showing a hotel option.

FIG. 4 is an example of a screen on a travel app that provides a number of collections of candidate hotels for a customer.

FIG. 5 is an example of a screen on a travel app showing additional details about a hotel selected by a customer.

FIG. 6 is an example of a screen on a travel app that provide information on a number of amenities offered by a hotel.

FIG. 7 illustrates a screen on a travel app that allows a customer to enter one or more email addresses that the travel app can then use to scan for flight and hotel confirmation messages according to an exemplary embodiment of the invention.

FIG. 8 an example of a screen on a travel app that allows the customer to enter special requests related to his or her hotel stay.

FIG. 9 depicts a screen on a travel app that allows the customer to enter flight preferences, according to an exemplary embodiment of the invention.

FIG. 10 shows an example of a screen on a travel app that provides a recommended event for a customer near the customer's selected hotel.

FIG. 11 is an example of a map presented by a travel app that shows a number of recommended events or destinations.

FIG. 12 is an example of a push message sent with a travel app reminding the customer of an upcoming trip and inviting the customer to make special requests prior to the trip.

FIG. 13 is an example of an upgrade offer that may be presented to a customer prior to arrival at a hotel.

FIG. 14 is a chart showing certain types of data that may be maintained by a business such as a financial institution (FI) and provided to a hotel according to an exemplary embodiment of the invention.

FIG. 15 is a chart showing various data sets that may be maintained by a financial institution (FI) and by a hotel, the combination of which may assist the hotel in enhancing the customer's stay.

FIGS. 16A and 16B show the top and bottom, respectively, of a screen that may be presented on a computer used by hotel staff during a customer's stay, wherein the data are provided by a business such as a financial institution.

FIG. 17 is an example of a push notification sent to a customer's mobile device notifying the customer that his or her special requests have been honored.

### DETAILED DESCRIPTION

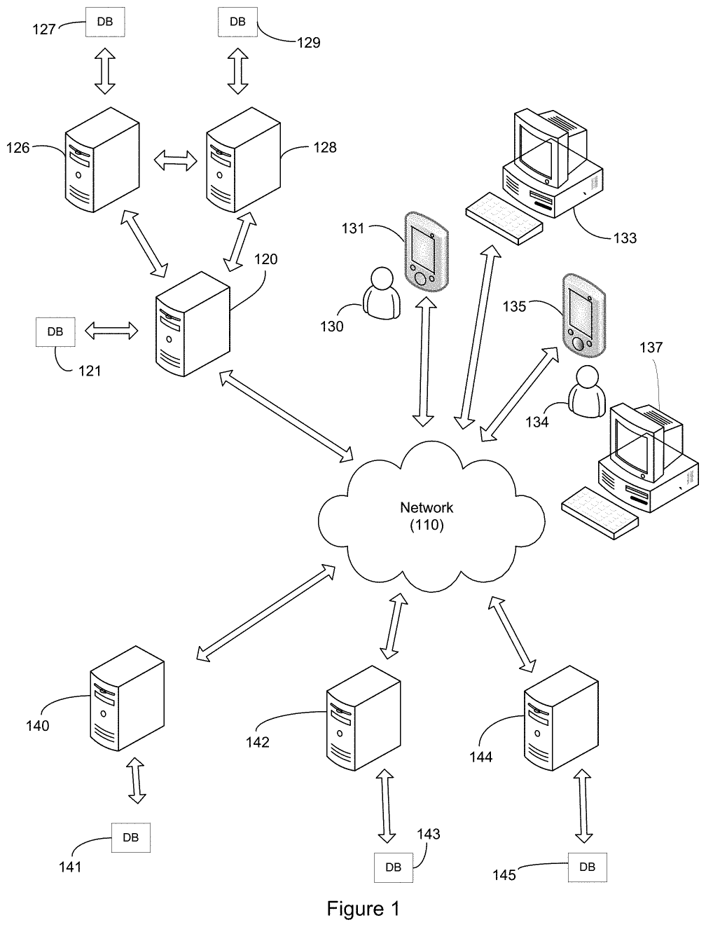

FIG. 1 is a diagram of a system for providing travel assistance to a traveler according to an exemplary embodiment of the invention. As shown in FIG. 1, the system may include one or more computer servers and networks. The system may be provided by a business or entity that has access to relevant information to enhance the customer's experience. According to one embodiment, the travel system is operated and maintained by a financial institution such as retail bank using, in part, data on travelers that are its retail bank customers, e.g., card holders of credit and debit cards issued by the retail bank. For simplicity, the examples set forth herein will be described in terms of a system operated by a financial institution (sometimes abbreviated herein as “FI”) for traveling and staying at a hotel. However, those skilled in the art will appreciate that other types of companies or businesses can operate and maintain the travel system for the benefit of their respective customers, and the system can be adapted for use at lodging facilities other than hotels.

Referring to FIG. 1, the system may be embodied primarily or entirely in a travel server 120, which may include a database 121, owned and/or operated by the financial institution that interfaces with a number of other servers and entities via one or more networks 110. The network 110 may comprise any one or more of the Internet, an intranet, a Local Area Network (LAN), a Wide Area Network (WAN), an Ethernet connection, a WiFi network, a Global System for Mobile Communication (GSM) link, a cellular phone network, a Global Positioning System (GPS) link, a satellite communications network, or other network, for example. The travel server 120 that is used by the financial institution can provide timely, relevant travel and lodging information to its customers, such as credit card holders, 130, 134. The travel server 120 can interface with other servers owned and/or operated by the financial institution. For example the travel server 120 may interface with a credit and debit card server 126 and associated database 127 that stores and processes credit and debit card transactions for card holders of the financial institution. The travel server 120 may also interface with a rewards program server 128 and associated database 129 that stores and processes rewards information for account holders at the financial institution. The foregoing description is merely one example of a configuration for such systems and functions and is not intended to be limiting.

Also shown in FIG. 1 is an account holder 130 of the financial institution who may communicate electronically with the travel server 120 of the financial institution using a mobile device 131 and/or a personal computing device 133. The mobile device 131 may comprise a smart phone, such as an Apple iPhone, Samsung Galaxy, or Amazon Fire Phone, or a tablet computer, such as an Apple iPad or Samsung Galaxy Tab, that includes a touch screen or other interactive display. The mobile device 131 preferably includes hardware and software to enable communication with a cellular network, a WiFi network, a Bluetooth channel, and/or other communication channel. The personal computing device 133 may comprise a laptop computer or desktop computer, for example. The account holder 130 may use the personal computing device 133 to execute various online banking transactions with the financial institution at home. FIG. 1 shows another other customer 134 of the financial institution, who may communicate with the financial institution using his or her mobile device 135 and personal computing device 137.

FIG. 1 illustrates additional servers operated by other entities that have information relevant or useful to the customers 130, 134 of the financial institution. According to one embodiment of the invention, the server 140 and associated database 141 may be a property management system (PMS) operated by a hotel that compiles and processes information on the hotel's guests and their hotel stays. The servers 142, 144 and associated databases 143, 145 may be servers operated by a third party vendors that compile and distribute services and information such as travel, dining and lodging recommendations and reviews, upsell services, travel itinerary services, and/or location services. Examples of such vendors include FourSquare, Yelp, TripAdvisor, Cloud9, TripIt, Upsell Solutions, iBeacon, and Connexions. Those skilled in the art will appreciate that other similar current and future systems and services may be utilized in connection with exemplary embodiments of the invention. The servers 140, 142, 144 can be linked to the travel server 120 of the financial institution through a public or private network.

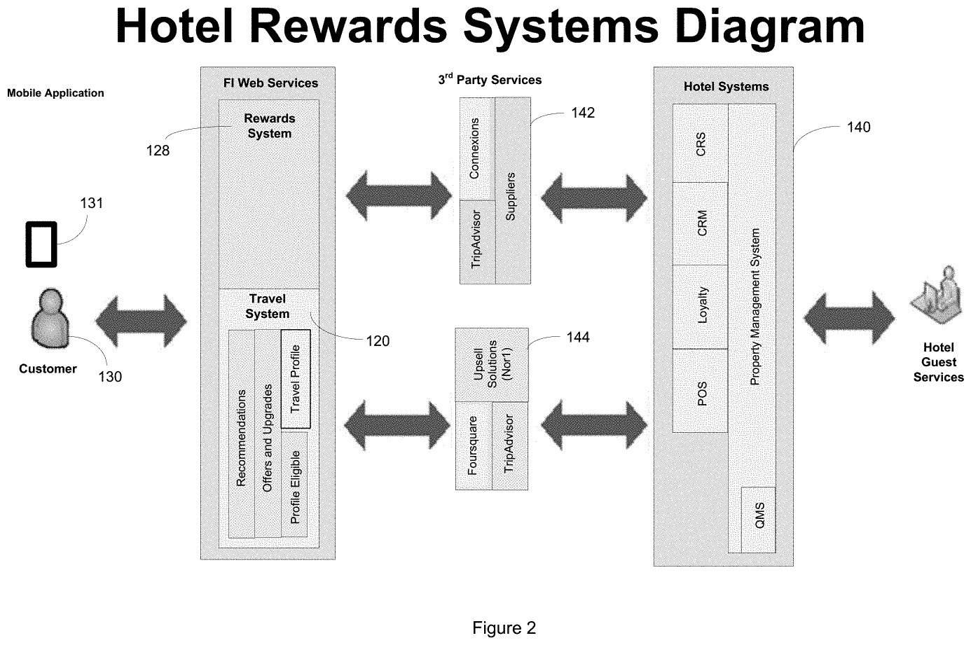

FIG. 2 illustrates interfaces between the functional modules of the travel system and third party systems according to one embodiment of the invention. As shown in FIG. 2, the customer 130 of the financial institution or other business may use his or her mobile device 131 to communicate with the travel system 120. The travel system 120 may store a travel profile and a module to determine profile eligibility. For eligible customers, the travel system 120 may provide offers, upgrades and recommendations. The system maintained by the financial institution may also include a rewards system 128 that stores information on its rewards program, participating customers, and their activities. The rewards server 128 may be linked to the travel system 120 to enable the travel system to provide special offers and services tailored to the customer, among other things.

FIG. 2 also depicts a number of third party servers 142, 144 representing servers operated by third parties providing various services and information that are useful to travelers, including customers of the financial institution. For example, as shown in FIG. 2, FourSquare and TripAdvisor may provide recommendations and reviews, Upsell Solutions may provide upsell marketing solutions such as Nor1, Connexions may provide booking services, and other suppliers may provide additional travel services. Other present and future systems, services and vendors may be used in connection with various embodiments of the invention.

Also shown in FIG. 2 is a property management system (PMS) that can be used by a hotel to manage certain hotel functions, such as maintenance of guest data, guest services, sales data, accounts receivable, and food and beverage services, among others. The property management system may include or interface with additional functional modules such as a point of sale (POS) system, a hotel loyalty sever and database, a customer relationship management (CRM) system, and a central reservation system (CRS), for example. The modules shown in FIG. 2 may be embodied in various servers and software modules designed to perform a specific function or functions. According to one embodiment, the modules may show or provide data sets including, but not limited, to customer spending in various categories, customer spending relative to other customers or account holders, spending at a particular merchant or its competitors, and other data provided by the customer or inferred from their financial data.

Having described an example of the hardware, software, and data that can be used to run the travel system, an example of the method and customer experience will now be described. The method will be described primarily as an example in which a customer of a financial institution (e.g., the holder of a credit card issued by a retail bank) downloads a software application (sometimes referred to as an “app”) of the financial institution and uses it for booking the trip and as a resource during the trip. However, those skilled in the art will appreciate that the principles of the invention can be applied to related circumstances, such as where the entity providing the app is a business other than a financial institution, or where the travel app functionality is provided through a browser on the customer's mobile device rather than through a software application (app) downloaded to the customer's mobile device, and with lodging establishments other than hotels.

Initially, the financial institution may send its customer an offer to download the travel app, either by email, text, or a personalized message on a website. The financial institution may send that offer message to all or a certain subset of its customers, e.g., card holders of a particular type of credit card. The message may indicate that the travel app can assist the customer by recommending desirable hotels based on the customer's profile, providing useful information about hotel amenities, recommending other events, destinations, or services outside of the hotel for the customer's trip, placing special requests with the hotel for the customer's stay, and/or providing special offers or services to the customer. The message may invite the customer to download the app onto his or her mobile device 131.

Once the customer has downloaded the travel app, e.g., by visiting an app store using his or her mobile device, the travel app may execute an onboarding process in which it asks the customer questions about the customer and his or her travel preferences. The questions can be presented to the customer through the app on his or her mobile device 131. The questions may be designed to elicit responses that provide useful information for the customer's profile, enabling the financial institution or other business to customize the services, offers and information that it sends to the customer and hotel before, during and after the trip. The questions may cover such topics as: the customer's preference for urban, rural, or coastal vacations, customer's home town, age, preferred price range for hotel and flights, identification of family members, whether the customer likes to arrive right on time or with plenty of time to spare, how the customer likes to spend his or her spare time, preferred types of food and drink, etc. The customer's responses provide useful data to allow the financial institution to refine the customer's profile data and customize the information and offers provided to the customer through the travel app.

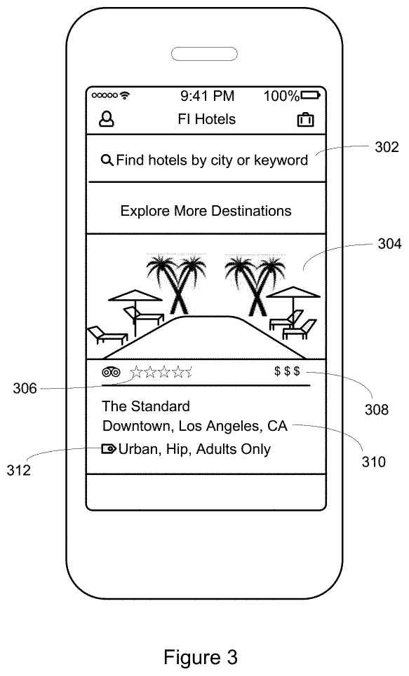

Once the customer has provided responses to the questions in the onboarding process, or has declined to answer them, the travel app presents a home screen. The home screen can suggest hotels to the customer that are tailored to the user's interests and tastes based on their customer profile, including their travel history, spend data, and stated preferences during the onboarding process. FIG. 3 depicts an example of a home screen. As shown in FIG. 3, the screen contains a search box 302 inviting the customer to find hotels by city or keyword. By tapping in the search box, the user can bring up a keyboard on the screen and use it to type in keywords for searching for hotels. The home screen also has a number of recommended hotels that have been identified by the financial institution based on the customer's profile. For example, as shown in FIG. 3, a hotel named “The Standard” is featured and described. The screen includes a photograph 304 of The Standard hotel, a quality rating 306 comprising by a number of stars, an indicator 308 as to how expensive the hotel is, a hotel address 310, and a number of tags or labels 312 that characterize the type of hotel it is (e.g., urban, hip, adults only). The tags or labels can be generated by automated searching of social media sites and processing of the unstructured data, sometimes referred to as a “social listening” service.

Because the travel app has profile information on the customer, it can suggest other hotels that are correlated with the customer's preferences and tastes. According to one embodiment, the customer can swipe upward on the screen to see more hotel options. For each hotel option, the travel app provides the relevant information shown in FIG. 3, e.g., a photograph of the hotel, a quality rating, an indicator as to how expensive it is, an address, and a number of tags or labels that characterize the type of hotel. The travel app can assemble such information on several hotels initially to give the customer recommendations as to hotel options that match his or her profile and preferences.

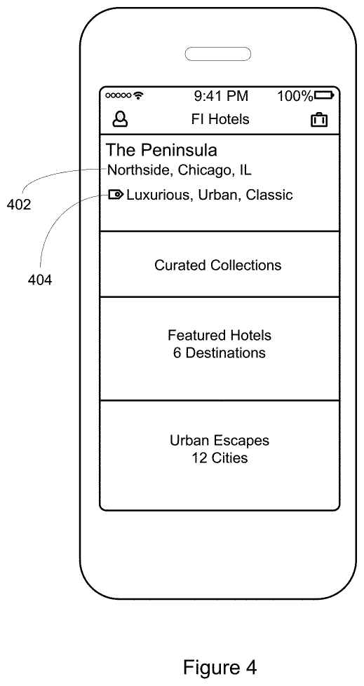

The travel app can also present the customer with the ability to view different “curated collections” of hotels. The concept of a curated collection is that the financial institution has selected these potential hotel options to best match the customer's preferences based on the customer profile. FIG. 4 illustrates a screen on the travel app that allows the customer to explore the curated collections. The travel app may group the hotels into distinct groups or collections for the customer's consideration. As shown in FIG. 4, the collections may include “Featured Hotels” and “Urban Escapes.” Although not shown in FIG. 4, other examples of collections presented by the travel app may include SXSW 2015, Beach Resorts, Explore Miami Attractions, and any other desired categories. The customer can browse these recommended hotels and attractions that have been custom picked by the financial institution.

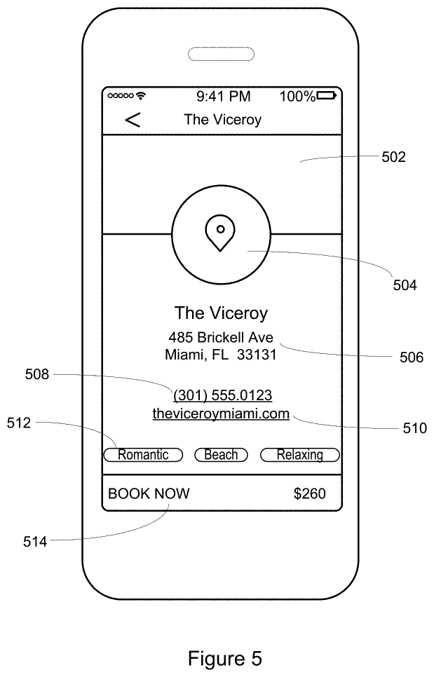

Once the customer has selected a hotel, the travel app can present the customer with additional information about the hotel through the travel app. As one example, as shown in FIG. 5, once the customer chooses The Viceroy Hotel by tapping on it, a screen is presented that provides a photograph 502 of the hotel, a map 504 showing the location of the hotel, the hotel address 506, a phone number 508 for the hotel, a website address 510, a set of labels 512 characterizing the hotel, and a booking button 514 that the customer can tap to book the hotel.

Although not shown in FIG. 5, the travel app can also be designed to provide multiple photographs of the hotel. For example, the customer may cycle through multiple photographs of the hotel by swiping the photograph region 502 left or right, which brings onto the screen a new photograph of the hotel.

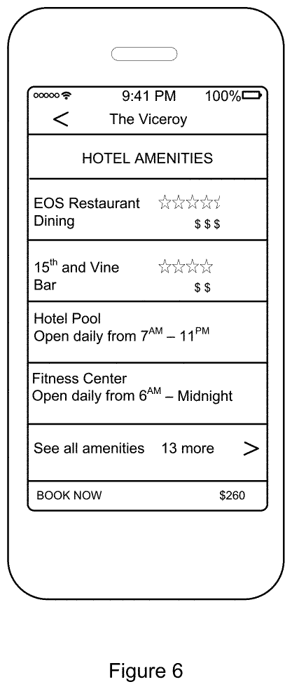

Similarly, by swiping upward on the screen, the customer is able to bring up a list of amenities available at the hotel. As shown in the example in FIG. 6, a number of amenities are listed for The Viceroy Hotel, such as the EOS Restaurant along with its quality rating and cost rating, the 15^{th} and Vine Bar with quality and cost ratings, the hotel pool and fitness center with hours of operation, and a button the customer can tap to identify additional amenities. The travel app therefore can provide a great deal of detailed information on the chosen hotel for the customer. The screen shown in FIG. 6 also includes a “BOOK NOW” button with a price to allow the customer to conveniently book the hotel using the travel app.

As described earlier, the travel system can assemble information for the customer profile through data accumulated by the financial institution (e.g., historical credit or debit card transaction data, and other customer data) and through customer responses to the initial questions presented by the travel app. In addition, the travel app may allow the customer to enter information directly into the travel app. A customer may choose to enter such data, for example, when the customer believes that the financial institution will use that data to make informed recommendations to the customer or to otherwise improve the usefulness of the travel app. Payment information is one type of information that the customer may choose to enter, e.g., a primary credit card with account number and expiration date, and a corporate credit card with account number and expiration date. The customer may also choose to input general information, such as the customer's home town, preferred language, and preferred currency. The travel app may enable the customer to enter such information by tapping a profile icon, and then an icon that indicates payment information, general information, or dining information, for example.

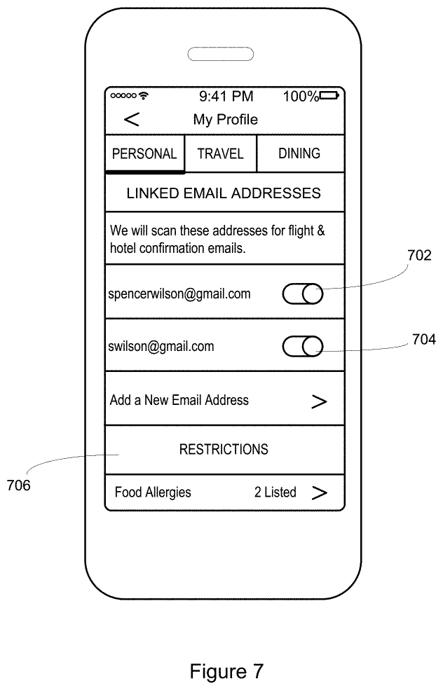

According to another aspect of the invention, the customer can provide one or more email addresses as part of his or her contact information. The customer can designate one or more of the email addresses as “linked email addresses,” and consent to allowing the financial institution to scan messages sent to or from such linked email addresses for flight and hotel confirmation email messages. As depicted in FIG. 7, the customer has entered two email addresses and has moved the toggle switches 702, 704 to the right, indicating that the financial institution is permitted to scan messages for flight and hotel confirmation emails. The financial institution, via the travel app, can then automatically scan the customer's email messages to pull relevant trip data into the travel app. For example, if the customer has booked a flight independent of the rewards program of the financial institution, the travel app can identify a confirmation email message from the airline and pull the relevant flight data into the travel app. The financial institution may utilize an internal or third party system that utilizes email scrubbing and/or parsing to derive the customer's itinerary from his or her email communications with the airline and hotel, for example. One example of such a third party system is the Tripit system of Concur Technologies, Inc., and other similar systems can be utilized. The automatic consolidation of information in this manner by the travel app makes the customer's experience much easier, as the customer does not have to manually search his or her email and manually enter the flight information into the travel app.

The screen in FIG. 7 also includes a section 706 allowing the customer to input various restrictions related to food, medicine, diet and health. In FIG. 7, the customer can tap on the bar entitled “Food Allergies” to enter various food allergies that he or she has. Although not shown in FIG. 7, the travel app can allow the customer to enter other restrictions, such as medicinal allergies, dietary restrictions, and health restrictions.

The travel app can also include a button entitled “CLEAR MY PROFILE” that allows the customer to clear his or her profile by tapping on the button and confirming his or her intent to delete the profile data.

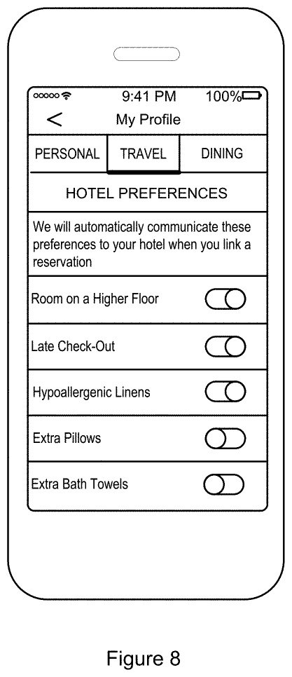

The travel app can also allow the customer to input various preferences of the customer related to the hotel. As shown in FIG. 8, the customer can use the toggle switches to communicate his or her preferences for a room on a higher floor, late check-out, hypoallergenic linens, extra pillows, and extra bath towels. Other preferences can be added to the travel app as desired, such as early check-in, as well as a general comment box allowing the customer to type in another preference or request. The travel app can automatically communicate these preferences and requests to the hotel when the customer's reservation is linked to or identified by the travel app, as indicated in FIG. 8.

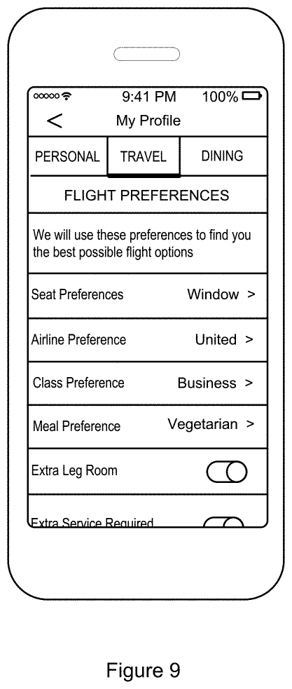

FIG. 9 illustrates another feature of the travel app regarding flight preferences according to an exemplary embodiment of the invention. As shown in FIG. 9, the travel app allows the customer to input a seat preference, airline preference, class preference, and meal preference. The travel app also allows the customer to request extra leg room and extra service. The travel app may also provide a text box allowing the customer to enter other requests relating to flights. The travel app can use the flight preferences to find the most desirable flight options for the customer, as indicated in FIG. 9. Other flight preferences can be defined and added to the travel app, as desired by the financial institution. The travel app can include functionality to find flights matching certain criteria specified by the customer, similar to the functionality provided by online travel sites such as Travelocity and Expedia, using third party data sources.

Also shown in FIG. 9 is a button to allow the customer to specify his or her dining preferences. According to one embodiment of the invention, when the customer taps the “DINING” button depicted in FIG. 9, the app presents a screen allowing the customer to specify his or her preferred dining options, such as types of cuisine, price range, quality rating, and other restaurant characteristics.

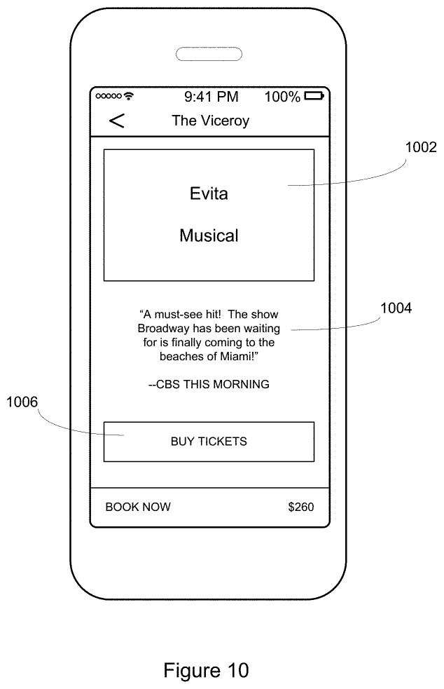

According to another aspect of the invention, the travel app can recommend activities, events, and destinations near the hotel that are curated specifically for that customer based on his or her customer profile. The travel app can facilitate the treatment of the customer as a preferred customer wherever they are during the trip, regardless of what the hotel can offer. The customized recommendations, offers and information provided by the travel app to the customer can increase customer loyalty to the financial institution. One example of such a recommendation is shown in FIG. 10. In this example, the travel app presents a recommendation to see the musical, Evita, based on the customer's profile. The travel app provides a photograph 1002 of the musical and provides a promotional review 1004 of it. It also includes a button 1006 enabling the customer to buy tickets conveniently. Other desirable events, museums, clubs, amenities, and destinations near the hotel can be presented to the customer based on the customer's profile, along with a convenient link to purchase tickets if required.

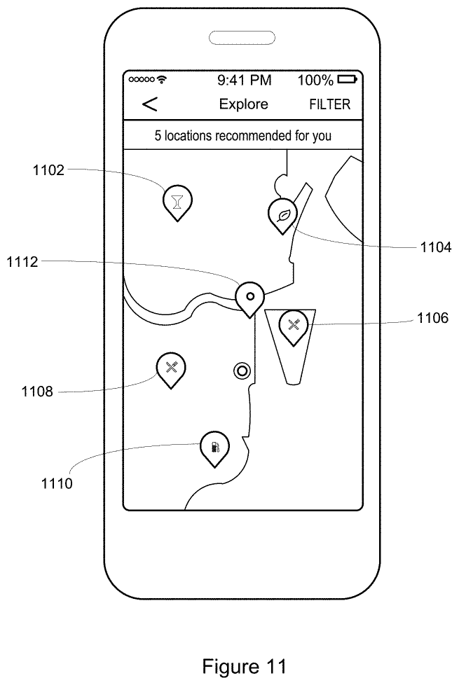

The travel app can provide a map showing the various recommendations, as shown in FIG. 11, according to an exemplary embodiment of the invention. The customer can access the map by swiping the screen in a predefined direction, or by tapping an icon, for example. The map may present a region near to the hotel or the customer's current location, along with a number of icons that show the location of various recommendations made by the travel app. In one particular example shown in FIG. 11, there is an icon 1102 for a night club, an icon 1104 for a botanical garden, icons 1106 and 1108 for restaurants, and an icon 1110 for a gas station. The icon 1112 can be provided to show the customer's current location or the location of the hotel, for example. The map in FIG. 11 identifies nearby events and destinations that are desirable to the customer (based on having been chosen to match the customer's profile) and that the customer otherwise might have trouble finding. The map also makes it easy for the customer to visualize the location of the various events and destinations relative to the location of the hotel or their current location.

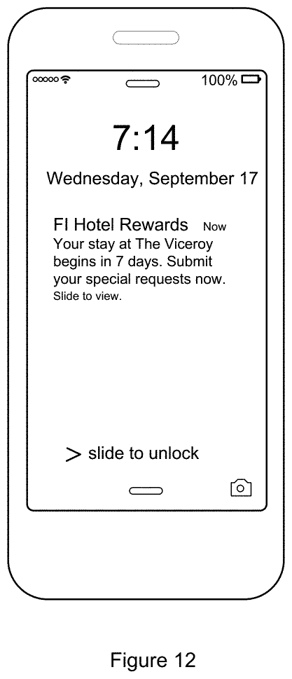

FIG. 12 illustrates another advantageous feature of the travel app. In FIG. 12, the travel app has pushed a message to the customer's mobile device 131 that reminds the customer of his or her upcoming reservation at the hotel. The message also invites the customer to submit special requests ahead of time. According to an exemplary embodiment of the invention, the travel app forwards the special requests to the hotel, which eliminates the need for the customer to find the hotel contact information, call the hotel, and make the request personally, a task that some customers may not particularly enjoy. The travel app thus makes the experience of placing a special request with the hotel more palatable for the customer, which may further enhance the customer's loyalty to the financial institution.

Although not shown in FIG. 12, the travel app may present a screen showing various requests that the customer can make, such as room on a high floor, late check-out, hypoallergenic linens, extra blankets, pull-out bed, European power adapter, lactose-free coffee creamer, a text box for other requests, champagne in the room (with the charge amount), and roses in the room (with the charge amount). Other requests can be incorporated into the travel app as desired.

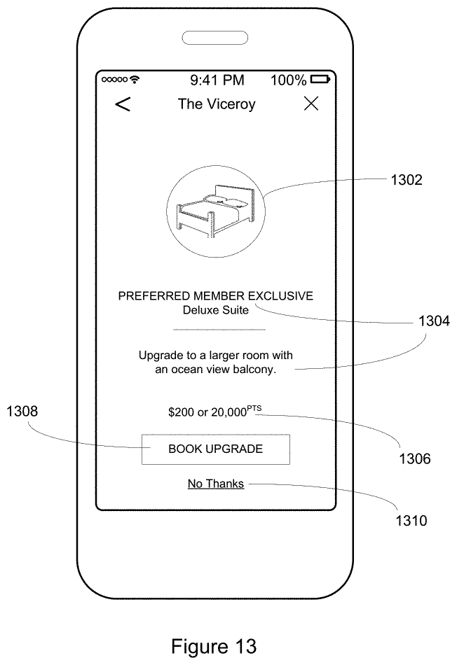

The travel app can also provide special or discounted offers or upgrades to the customer according to another embodiment of the invention. For example, prior to the customer's arrival, the travel app can send a push message to the customer alerting them to the offer. One example of such a push message might tell the customer that, “as a preferred customer of the financial institution, we are able to offer you a reduced rate for an upgrade to a Deluxe Suite.” The travel app may then present a screen showing more details of the special offer. FIG. 13 shows such an example, with a picture of the suite 1302, a description of the offer 1304, the price 1306 of the offer (which may include cash and/or rewards points from a rewards program at the financial institution or other business), a button 1308 to accept the offer and book the upgrade, and a button 1310 to decline the offer. The special offer, because it is generated and communicated by the financial institution to the customer, may again enhance the customer's loyalty to the financial institution.

As mentioned earlier, hotels typically do not have extensive information about their guests other than their check-in and check-out dates, address and contact information, credit card account number, data on the spending levels of their guests, and data on the room preferences of their guests. Furthermore, hotels generally have little or no opportunity to obtain such information from their guests. The travel app is preferably designed to enhance the travel experience for customers of the financial institution by facilitating and enabling higher level service at participating hotels. The financial institution's customer profile data can provide a more actionable, holistic view of hotel guests that is desirable to the hotel. The travel app can also provide hands-free payment at the hotel for participating hotels. The financial institution can transfer payment information in the background to backend systems, such as those operated by the hotel. The customer can benefit from frictionless payment by eliminating the need to pull out and present a payment instrument for every purchase within hotel property.

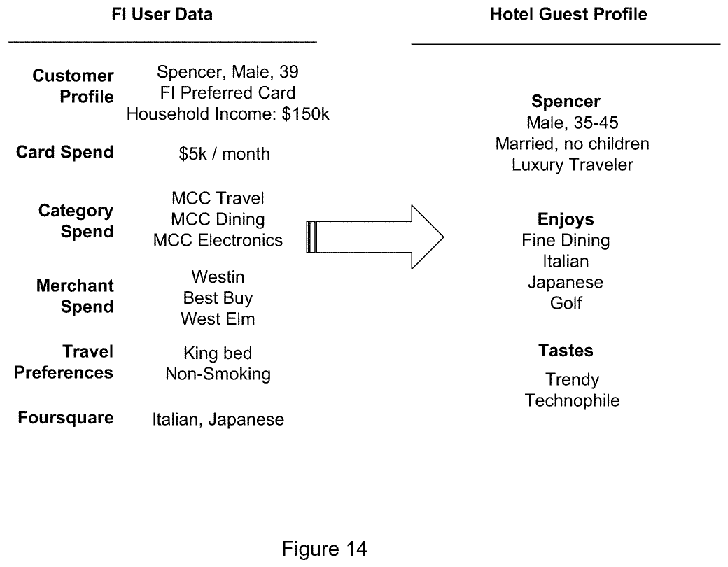

FIG. 14 is a chart that shows the type of data that a financial institution may maintain and that may be desirable for the hotel to access, such as the customer's age, household income range, monthly credit card spending level, spending levels according to merchant category code (MCC), spending levels at particular merchants, travel preferences, and food preferences. The hotel may be able to use this data to better understand its guests and improve their experience at the hotel. For example, given the information maintained by the financial institution in the example of FIG. 14, the hotel may learn that the guest is married, has no children, is a luxury traveler, enjoys fine dining at Italian and Japanese restaurants, enjoys golf, and is trendy and a technophile. This information allows the hotel to make specific recommendations to improve the customer's experience.

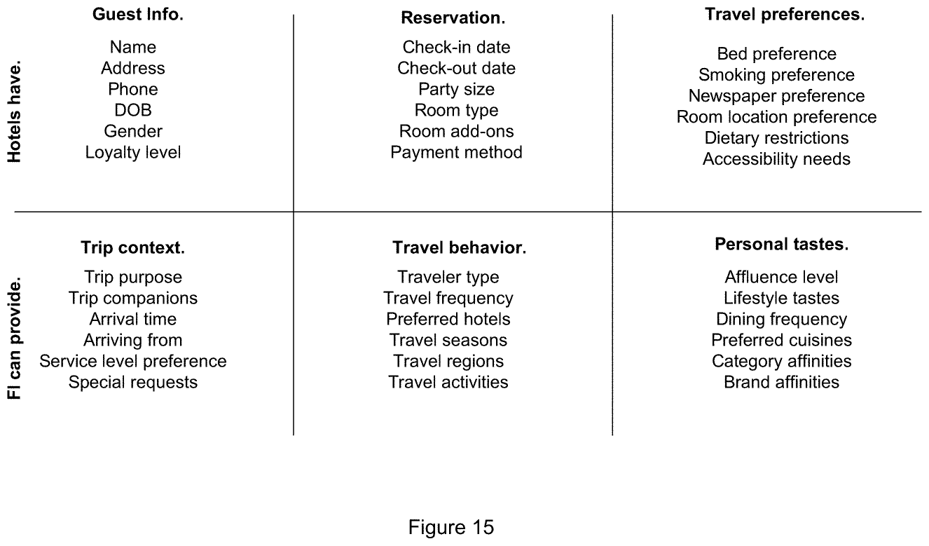

FIG. 15 provides a more detailed example of the information typically maintained by the financial institution and the information that the hotel may have. Exemplary embodiments of the invention can provide the advantage of allowing this complementary data to be combined for the benefit of the hotel guest. Certain data in the customer profile maintained by the financial institution can be shared with partner hotels for the duration of the stay and provides actionable service recommendations to hotel staff.

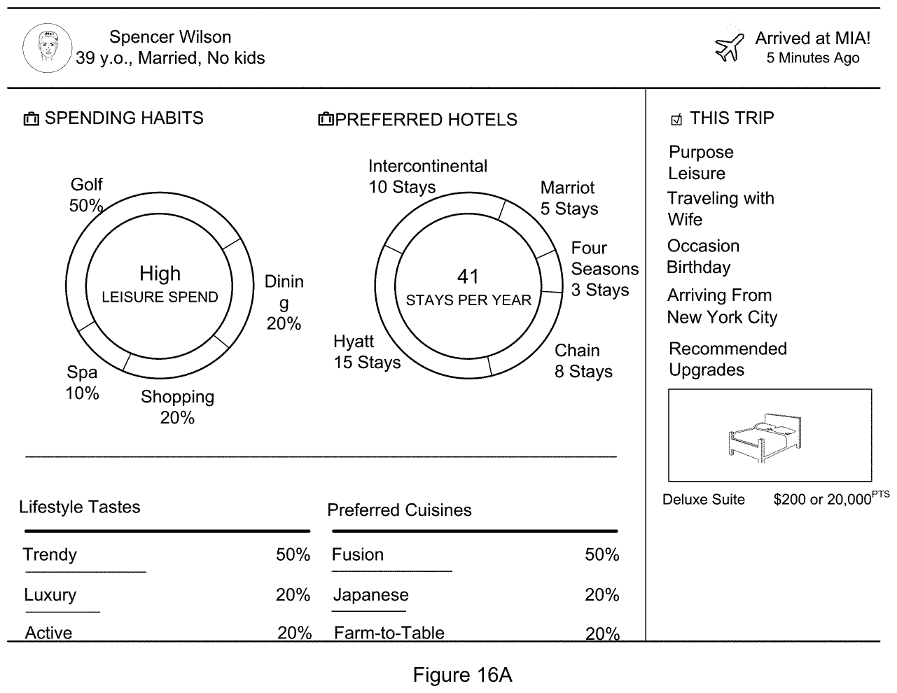

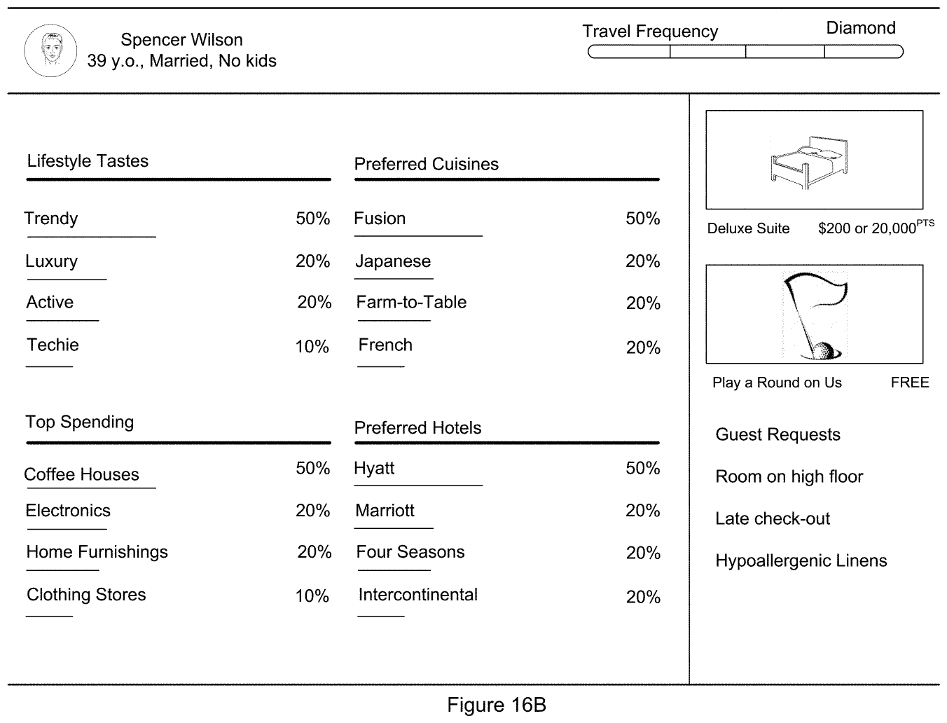

FIGS. 16A and 16B provide one example of how this information may be shared with the hotel on a time-limited basis. FIG. 16A depicts an example of the top half of a screen that a hotel receptionist can pull up on his or her desktop computer behind the desk prior to the customer arriving at the hotel. The financial institution configures and controls access to this screen for a defined period of time, after which the hotel no longer has access. As shown in FIG. 16A, the screen includes relevant data on the customer, such as name, age, picture, marital status, whether he has children, when he arrived at the airport, spending habits, details about preferred hotels, purpose of the trip, other parties on the trip such as a spouse, the occasion for the trip, the departure location, and recommended upgrades. The hotel staff can use this information to provide timely, relevant recommendations, offers, and information to the customer.

FIG. 16B shows the bottom half of the screen. As shown in FIG. 16B, the screen presented to the hotel staff may also provide information on the customer's lifestyle tastes, preferred cuisines, types of merchants at which the customer does his or her top spending, and preferred hotels. FIG. 16B also identifies another special offer, in this example to play a free round of golf. The special requests of the customer are also displayed, such as room on a high floor, late check-out and hypoallergenic linens. This information can give the hotel staff a greater opportunity to foster loyalty with the customer by knowing his or her preferences and making customized recommendations.

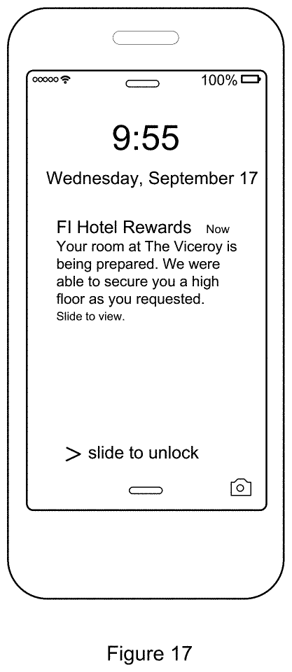

According to another embodiment of the invention, the travel app can take advantage of another opportunity to communicate with the customer prior to their arrival. According to one example, the travel app can send a message to the customer shortly before he or she is expected to arrive at the hotel. This push message can serve as an opportunity to fulfill a special request, offer a discounted upgrade, or simply assure the customer that the hotel is awaiting their arrival. FIG. 17 provides an example of such a message. In FIG. 17, the travel app informs the customer that his or her room at the hotel is being prepared and that his or her request for a room on a high floor will be honored. The message is another example of an opportunity to enhance the customer's loyalty by demonstrating the commitment of the financial institution and/or hotel to honoring the customer's special requests and ensuring that the accommodations have been prepared in anticipation of the customer's arrival.

According to various embodiments of the invention, the travel app can facilitate a conversation between the financial institution or hotel and the customer from post-booking to arrival. Once the customer enters the hotel, he or she has access to hands-free payment and expedited check-in, according to one embodiment. And throughout the customer's stay, the hotel staff can use the data from the financial institution to enhance and improve their service to the customer.

The computer implemented system, method and medium described herein can provide the advantage of enhancing customer loyalty to a financial institution or other business, based on the perception that the financial institution is improving the customer's experience on the trip, regardless of what the hotel itself can provide. By gathering and processing various data sources that are relevant and valuable to the customer, and sending the customer and the hotel relevant, timely information, recommendations, and special offers related to the hotel or the region where the hotel is located and tailored to the customer, the financial institution can guide the customer to desirable destinations and events, and significantly enhance the customer's overall enjoyment of the travel experience.

Although the foregoing description has focused primarily on a financial institution assembling relevant data sets, processing the data, and sending the relevant data at appropriate times to its customer and/or a participating hotel, the system may be operated and maintained by other types of commercial entities who may configure the system to provide similar advantages to their customers. In additional, while the foregoing description has focused primarily on the customer's travel to and stay at a hotel, the principles of the invention can be applied to other lodging establishments where the operating entity can assemble and provide relevant, timely information to its customers and to the lodging establishment to enhance the customer's experience.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Data and information maintained by the servers shown by FIGS. 1-2 may be stored and cataloged in one or more databases, which may comprise or interface with a searchable database and/or a cloud database. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 110 in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network, e.g., 110 in FIG. 1, may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 110 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 110, may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of a mobile device 131 and a personal computing device 133 are shown in FIG. 1, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile device 131 and personal computing device 133 may include various connections such as a cell phone connection, WiFi connection, Bluetooth connection, satellite network connection, and/or near field communication (NFC) connection, for example.

As described above, FIG. 1 includes a number of servers 120, 126, 128, 140, 142, 144 and user communication devices 131, 133, 135, 137, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIGS. 1-2 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices 131, 135 or personal computing device 133, 137. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A computer-implemented method for providing travel and lodging information to a mobile device of a customer of a retail bank, the method comprising:
storing customer profile data on a computer server, the profile data comprising historical credit card transaction data maintained by the retail bank;
storing hotel profile data on a plurality of hotels on the computer server, wherein the hotel profile data comprises data on characteristics of each hotel;
linking customer profile data with customer rewards program data for the retail bank;
linking one or more third-party hotel property management system with the hotel profile data, wherein the third-party hotel property management system includes information on one or more hotel guests and their hotel stays;
linking one or more third-party vendor servers with the hotel profile data, wherein the third-party vendors servers include information pertaining to travel, dining, and lodging recommendations;
generating with a specialized computer processor a list of candidate hotels based on a relationship between the customer profile data, the hotel profile data, the third-party hotel property management system information, the third-party vendor information, and the customer rewards program data;
sending to the customer's mobile device, via an interactive user interface, the list of candidate hotels, wherein the list of candidate hotels includes one or more images of at least one of the candidate hotels, information including at least pricing and amenities for the candidate hotels, and at least one comparison between two of the candidate hotels;
receiving from the customer's mobile device via a network a selection of a hotel within the list of candidate hotels;
providing, via the one or more third-party vendor servers, a hotel booking interface;
receiving from the customer's mobile device a booking request for the selected hotel;
determining, from a customer profile, that the customer is eligible for a list of potential upgrades or offers;
sending the list of potential upgrades or offers to the customer;
sending, based on the customer's selection of a hotel and the one or more third-party vendor servers, one or more recommendations for activities during the time period for the selected hotel stay;
receiving from an eligible customer's mobile device via a network a selection of an acceptance or rejection of one or more of the upgrades or offers in the list of potential upgrades or offers;
inviting the customer, via the customer's mobile device, to make a special request to the selected hotel and relaying the customer's special request to the selected hotel via a network; and
prior to the customer's arrival at the selected hotel, sending to the selected hotel via a network a data set including customer profile data that is derived from financial transactions independent of the selected hotel and other data maintained by the retail bank and not maintained by the selected hotel.

2. (canceled)

3. The method of claim 1, further comprising the step of sending to the customer's mobile device at least one of a recommended event and a recommended destination, proximate to the hotel, based on the customer profile data.

4. The method of claim 3, further comprising: causing a map to be displayed on the customer's mobile device, wherein the map illustrates the at least one of a recommended event and a recommended destination.

5. The method of claim 1, further comprising the step of sending to the customer's mobile device at least one room upgrade offer.

6. The method of claim 1, wherein the step of inviting the customer to make a special request to the selected hotel comprises:
sending to the customer's mobile device at least one hotel room preference; and
inviting the customer to specify a hotel room preference.

7. The method of claim 6, wherein the at least one hotel room preference comprises at least one of: a hotel floor preference, a late check-out preference, an early check-in preference, and a preference for specified bedding or bath amenities.

8. The method of claim 1, further comprising sending a message to the customer's mobile device confirming that the customer's special request has been honored.

9. The method of claim 1, wherein the hotel profile data is derived at least in part from automated searching of social media postings.

10. The method of claim 1, further comprising the steps of:
inviting the customer to identify at least one customer email address;
requesting permission to search the at least one customer email address for messages related to a trip to the selected hotel; and
deriving travel information from the messages; and
storing the derived travel information within a travel app on the customer's mobile device.

11. The method of claim 1, wherein the customer profile data comprises at least one of: (a) historical data on financial transactions executed by the customer, (b) information input by the customer into his or her profile, and (c) passively collected data on other interactions with the financial institution.

12. A computer-implemented system for providing travel and lodging information to a mobile device of a customer of a retail bank, the system comprising:
a computer server containing a processor that is programmed to:
store customer profile data on a computer server, the profile data comprising historical credit card transaction data maintained by the retail bank;
store hotel profile data on a plurality of hotels on the computer server, wherein the hotel profile data comprises data on characteristics of each hotel;
link customer profile data with customer rewards program data for the retail bank;
link one or more third-party hotel property management system with the hotel profile data, wherein the third-party hotel property management system includes information on one or more hotel guests and their hotel stays;
link one or more third-party vendor servers with the hotel profile data, wherein the third-party vendors servers include information pertaining to travel, dining, and lodging recommendations;
generate a list of candidate hotels based on a relationship between the customer profile data, the hotel profile data, the third-party hotel property management system information, the third-party vendor information, and the customer rewards program data;
send to the customer's mobile device, via an interactive user interface, the list of candidate hotels, wherein the list of candidate hotels includes one or more images of at least one of the candidate hotels, information including at least pricing and amenities for the candidate hotels, and at least one comparison between two of the candidate hotels;
receive from the customer's mobile device via a network a selection of a hotel within the list of candidate hotels;
provide, via the one or more third-party vendor servers, a hotel booking interface;
receive from the customer's mobile device a booking request for the selected hotel:
determine, from a customer profile, that the customer is eligible for a list of potential upgrades or offers; send the list of potential upgrades or offers to the customer;
send, based on the customer's selection of a hotel and the one or more third-party vendor servers, one or more recommendations for activities during the time period for the selected hotel stay;
receive from an eligible customer's mobile device via a network a selection of an acceptance or rejection of one or more of the upgrades or offers in the list of potential upgrades or offers;
invite the customer, via the customer's mobile device, to make a special request to the selected hotel and relaying the customer's special request to the selected hotel via a network; and
prior to the customer's arrival at the selected hotel, send to the selected hotel via a network a data set including customer profile data that is derived from financial transactions independent of the selected hotel and other data maintained by the retail bank and not maintained by the selected hotel.

13. (canceled)

14. The system of claim 12, wherein the computer processor is further programmed to send to the customer's mobile device at least one of a recommended event and a recommended destination, proximate to the hotel, based on the customer profile data.

15. The system of claim 14, wherein the computer processor is further programmed to cause a map to be displayed on the customer's mobile device, and wherein the map illustrates the at least one of a recommended event and a recommended destination.

16. The system of claim 12, wherein the computer processor is further programmed to send to the customer's mobile device at least one room upgrade offer.

17. The system of claim 12, wherein as part of the step of inviting the customer to make a special request to the selected hotel, the computer processor is further programmed to:
send to the customer's mobile device at least one hotel room preference; and
invite the customer to specify a hotel room preference.

18. The system of claim 17, wherein the at least one hotel room preference comprises at least one of: a hotel floor preference, a late check-out preference, an early check-in preference, and a preference for specified bedding or bath amenities.

19. The system of claim 12, wherein the computer processor is further programmed to send a message to the customer's mobile device confirming that the customer's special request has been honored.

20. The system of claim 12, wherein the hotel profile data is derived at least in part from automated searching of social media postings.
